(19) United States
(12) Patent Application Publication
(10) Pub. No.: US 2003/0200269 A1
(43) Pub. Date: Oct. 23, 2003

(54) Information processing device and information processing system

(76) Inventors: Hidejirou Maehara, Kanagawa (JP); Yuuichi Mikuni, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/370,516

(22) Filed: Feb. 24, 2003

(30) Foreign Application Priority Data
Feb. 25, 2002 (JP) 2002-048382

(51) Int. Cl. G06F 15/177; G06F 15/16

(52) U.S. Cl. 709/206; 709/220

(57) ABSTRACT

A multi-functional apparatus functions as a Web server, and portable telephones, personal computers function as clients. A manual that guides the setting operation (i.e., simulates the progress of the proceeding of the setting operation, by adding voice to a motion picture) is provided as a Web page. A user inputs instructions on a screen displayed on a display of the portable telephone. The instructions input are transmitted to the multi-functions apparatus. The multi-functional apparatus changes own settings according to the instructions received and notifies the portable telephone about the new settings.

### BACKGROUND OF THE INVENTION

1) Field of the Invention

The present invention relates to an information processing device that operates based on conditions set manually and has a Web page to guide input of the conditions. This invention also relates to an information processing system that employs this information processing device.

2) Description of the Related Art

Generally the information processing devices require setting of operating conditions. The operating conditions can be set using a keyboard, a mouse, or a soft key displayed on a screen. If the user does not understand how to input a certain operating condition, then he refers to an operation manual of the information processing device.

However, along the progress of multi-functions of information processing device in recent years, there are a wide range of settings of operating conditions, and the operating methods have become complex and diversified. To cope with this situation, the input operation is facilitated by employing a method of making the user follow the procedure according to instructions displayed on a setting screen of the input console section. However, even though this method is employed, the user has to refer the operation manual if he does not understand something. There is a limit to the user's understanding from the explanation in the operation manual, which is motionless.

Therefore, there is a method that employs what is called a “live manual” that has voice attached to a motion picture such as animation or video, as the manual. This manual simulates the progress of a setting procedure that the user carries out from the input console section installed on the apparatus. There is also a proposal that the “live manual” is provided from a Web server via a communicating unit to enable the user to utilize this manual at any place. As one example, Japanese Patent Application Laid-Open No. 2001-297087 (a first conventional example) discloses a system equipped with a server that can provide operating information on a Web page. In this example, the system stores an operating procedure of an apparatus that includes a console screen according to a GUI (Graphic User Interface), as animation data in a database. The system provides this operating procedure to users via a network such as the Internet. The first conventional example also shows a structure that registers user's operation know-how into the database, and enables users to browse this data.

When the Web server provides the “live manual” via the communicating unit, a user can browse this manual when necessary, by preparing an information communication terminal that can access the Web server. Therefore, not only the user can utilize this manual like in the first conventional example, the user can also use the prepared “live manual” to learn about a new product when the information processing device is put into the market. The user can also use this manual to explain about the new product in the marketing activity, and explain about the operation and utilization method of the new product at a customer side.

Although the first conventional example provides the operating information (i.e., the manual) in an understandable manner, this method does not enable the operation by using the actual apparatus. Therefore, even when the user understands the operating procedure from the provided manual, the user cannot confirm whether the apparatus executes the operation as desired if the user accesses the manual at a position far from the apparatus. As a result, it is not possible to obtain user's reliability. Further, even when the user understands the operating procedure from the provided manual, the apparatus does not execute the operation unless the user applies this method on the actual apparatus and does the setting. In other words, the user needs to carry out the operation while browsing the manual. In this respect, this manual is no more than a manual booklet, and this leaves a problem in the actual operation.

Japanese Patent Application Laid-Open No. 2001-217948 (a second conventional example) proposes a method for instructing the information processing device to execute the operation based on a user setting. The second conventional example uses a Web server as means that replaces the input console section that is provided on the information processing device main body. The Web server provides a portable telephone (including an integration of Personal Digital Assistants (PDA)) with a Web page that sets an operating condition. The portable telephone receives a dialog screen as a Web page for setting a printing condition to a printer, based on which the user carries out the setting and returns this information to the printer. Through the buildup of this Web page, a condition setting program loaded on the printer instructs the printer to execute the print operation following the setting condition.

However, the dialog screen transmitted as the Web page to set the printing does not function as a manual for users who do not understand the operation. In other words, the control operation of the apparatus using the Web page of the second conventional example is not proposed as a “live manual” that is designed for ignorant users. The dialog screen is not designed to set the operating condition based on the operation following the guide, instruct the execution of the operation based on the set condition, or confirm whether the input has been carried out without an error based on a result of the execution. Instead, this dialog screen shows only one of the setting procedures based on the assumption that the user already has the knowledge on the operating method.

### SUMMARY OF THE INVENTION

It is an object of this invention to solve at least the problems in the conventional technology.

The information processing device according to one aspect of the present invention comprises a console for inputting a setting condition; a controller that controls an operation based on the setting condition input; and a server that has a Web page to guide a user about an input of the setting condition on the console, recognizes the input of the setting condition through an access to the Web page, and instructs the controller to control the operation based on the setting condition recognized.

The information processing system according to another aspect of the present invention comprises an information processing device having a console for inputting a setting condition; a controller that controls an operation based on the setting condition input; and a server that has a Web page to guide a user about an input of the setting condition on the console, recognizes the input of the setting condition through an access to the Web page, and instructs the controller to control the operation based on the setting condition recognized; and a client terminal that is connected to the information processing device via a communicating unit, wherein the client terminal instructs to input the setting condition based on a request for access to the Web page.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a schematic diagram that shows a structure of a multi-functional apparatus system according to the embodiment of the present invention; and

FIG. 2 is a block diagram that shows a structure of the Web server function of the multi-functional apparatus shown in FIG. 1.

### DETAILED DESCRIPTION

An exemplary embodiment of the present invention will be explained with reference to the accompanying drawings. The present invention is by no means limited only to this embodiment.

An information processing system that uses an information processing device according to the present invention as a constituent element of the information processing system will be explained.

In the present embodiment, in order to guide ignorant users about an operating method for them to easily understand the input method and enable them to carry out the setting and instruct the execution in the set condition, the information processing device has a guidance Web page. The information processing system having the information processing device has a Web so that a client terminal having a Web browser can access the guidance Web page.

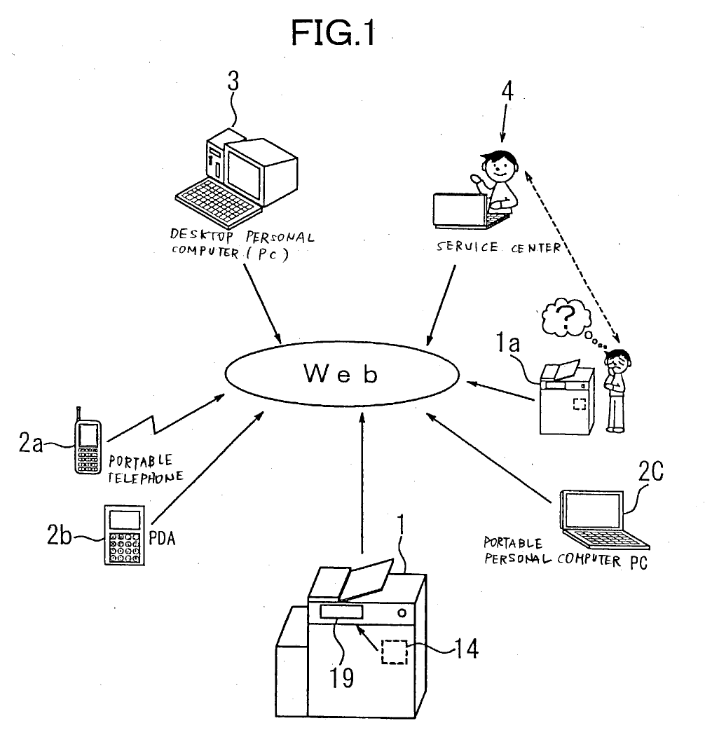

FIG. 1 is a schematic diagram that shows a structure of the information processing system according to the present embodiment.

This information processing system has an information processing device 1. The information processing device 1 is, for example, a multi-functional apparatus, that is an apparatus that has a copying function, a facsimile function, and a printer function, and that can process image information input from the outside via a communication interface (I/F), by using these functions. The information processing system enables various kinds of information processing terminals to utilize this multi-functional apparatus 1. The information processing terminals that utilize the multi-functional apparatus 1 may be a portable telephone 2a, a personal digital assistant (PDA) 2b, a portable personal-computer (PC) 2c, and a desktop personal-computer (PC) 3 as a fixed terminal. These information processing terminals are connected to the multi-functional apparatus 1 via a network.

The information processing system utilizing the multi-functional apparatus shown in FIG. 1 builds up the Web by using the multi-functional apparatus 1 as a Web server, which has a guidance Web page 14, and using the information processing terminals as client terminals, which have Web browsers.

The guidance Web page 14 has a manual of an input operation prepared in advance. This manual shows input keys or the like loaded on the console panel of the apparatus. In order to instruct an operating method that shows the operation and a procedure to carry out a desired setting, what is called the “live manual” is used by attaching voice to a motion picture such as an animation or video, thereby to simulate the proceeding of the setting procedure. This enables any person to easily carry out the setting work.

In order to carry out the input operation according to the “live manual” obtained through access to the guidance Web page 14, each client information processing terminal has a Web browser to carry out a processing corresponding to the guidance Web page, a video display section (display), and an audio output section (speaker) that output the information of the process results. It is possible to provide this facility by using existing information processing terminals, and by loading existing Web browsers onto these terminals.

The setting work proceeds based on the instruction from each client (i.e., each information processing terminal) that receives the provision of a manual. The user carries out an input operation on the Web (on the manual) using keys indicated by the manual (i.e., the screen display or voice) for each step of the operating procedure provided to the client terminal, and shifts to the next input operation. After ending the setting, when the user finally instructs the execution of the processing from the client terminal, the multi-functional apparatus 1 executes the operation based on the setting. When the user has instructed the execution of the processing, the multi-functional apparatus 1 notifies the client terminal about the setting contents. The multi-functional apparatus 1 informs the user in voice about the progress of the processing until when the execution of the instructed processing ends. The multi-functional apparatus 1 provides this service for the user who operates at the terminal far from the multi-functional apparatus 1 and who cannot understand the processing state of the multi-functional apparatus 1.

In order to receive the manual service from the guidance Web page 14, a Web browser is necessary. Therefore, each information processing terminal has a Web browser. Based on this, it is possible to carry out the setting by utilizing the Web, at the desktop PC 3 far from the multi-functional apparatus 1, or at the portable telephone 2a, the PDA 2b, and the portable PC 2c, as portable terminals. In the present embodiment, in addition to this arrangement, the multi-functional apparatus 1 main body also has a Web browser, which utilizes the manual obtained by accessing the guidance Web page 14. As an example of the multi-functional apparatus 1 main body, the video display section provided on a console panel 19 shows a manual image obtained from the guidance Web page 14, thereby to make the multi-functional apparatus function to help the input operation.

As another form of utilization, a service center 4 (refer to FIG. 1) that provides the multi-functional apparatus with services has a Web browser to access the guidance Web page held by the multi-functional apparatus. When the service center 4 receives a notice from a user that the user cannot carry out an input operation at a multi-functional apparatus 1a that has the guidance Web page 14, the service center 4 accesses the guidance Web page of this multi-functional apparatus 1a. The service center 4 carries out a user's desired setting to the multi-functional apparatus 1a on behalf of the user who cannot carry out the input operation, thereby to make the multi-functional apparatus 1a execute the operation following the setting. In addition to this service, when a new product is put into the market, the service center provides users with services for them to learn about the new product, explain about the new product in the marketing activity, or explain about the operation and utilization method to customers to whom the new product is introduced, by using the “live manual” obtained from the guidance Web page 14.

The multi-functional apparatus 1 that has the Web server function that constitutes the information processing system will be explained in detail. The Web server function to build up the Web in the multi-functional apparatus system will be mainly explained below, and the explanation about the copying function, the facsimile function, and the printer function of the multi-functional apparatus 1 will be omitted. It is possible to implement these functions by using the conventional art.

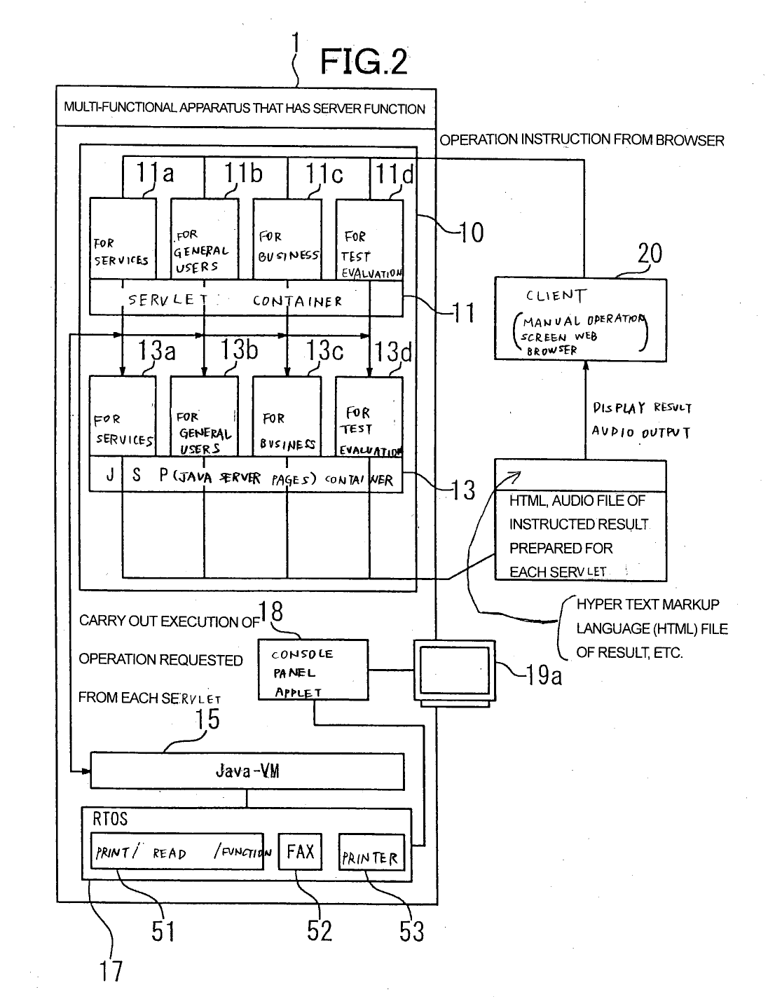

FIG. 2 is a block diagram that shows a structure of the multi-functional apparatus according to the present embodiment.

Referring to FIG. 2, the processing system of the multi-functional apparatus 1 that has the Web server function comprises a Real Time Operating System (RTOS) 17, a Java (registered trademark)-Virtual Machine (VM) 15, and a Java (registered trademark) application 10.

The Java (registered trademark)-VM 15 receives an execution instruction expressed in Java (registered trademark) from the Java (registered trademark) application 10 to be explained later, and converts this execution instruction into data that the RTOS 17 can understand to implement the copying function, the facsimile function, and the printer function of the multi-functional apparatus.

The RTOS 17 controls a copying function 51, a facsimile function 52, and a printer function 53 having printing and reading section, based on instructions from the Java (registered trademark)-VM 15. The RTOS 17 also gives an instruction to a console panel applet 18 to operate a video display 19a provided on the console panel, to make it possible to use the video display 19a as a monitoring screen at the time of the setting work.

The Java (registered trademark) application 10 implements the Web server function, and constitutes the Web together with the Web browser provided in a client (information processing terminal) 20. Therefore, the Java (registered trademark) application 10 has a Web server that operates following the operation instruction from the Web browser, and also has a mail processing section not shown.

The Web server has a function of dynamically generating a Web page based on a built-in server side Java (registered trademark) (servlet). In the present example, a servlet container 11 has servlets by application, for services 11a, for general users 11b, for business 11c, and for test evaluation (for development and design) 11d, respectively. A Java (registered trademark) Server Pages (JSP) container 13 has JSPs for services 13a, for general users 13b, for business 13c, and for test evaluation 13d, corresponding to the applications divided by the servlets respectively. The Web server transmits the Web pages prepared by the servlets as JSP files in the Hyper Text Markup Language (HTML) format.

The Web server function of the system utilizing the multi-functional apparatus will be explained. First, the client (information processing terminal) 20 makes a request for access to the guidance Web page 14 based on an assignment of a Uniform Resource Locator (URL). The Java (registered trademark) application 10 of the Web server receives this request, prepares an initial screen to provide manual services, and transmits this initial screen to the client 20 as an HTML file. The client 20 selects a desired manual to be provided from among the manuals by application (i.e., for services, for business, for general users, and for design evaluation) shown on the initial screen. Users other than the general users can access the guidance Web page by inputting their passwords.

When the user has selected a manual of which provision is desired, the client 20 transmits to the Web server a request for access to the guidance Web page 14 again. The client 20 receives the provision of the next page that is necessary to carry out the setting following the selected manual. The client 20 repeats this process. For example, when the client 20 has selected a manual for general users, the client 20 carries out a detailed setting such as, which one of the copying function, the facsimile function, and the printer function of the multi-functional apparatus 1 is to be utilized, then what kind of processing is to be carried out to which document (file), and what property is to be used for the processing, etc. In this case, the guidance Web page 14 explains in detail, with video and audio, about what will result when the user changes the input setting items, the setting order, the setting method, and the setting values, etc. The guidance Web page 14 facilitates the user's setting work to satisfy the user's requirement. In the above setting work, upon recognizing the setting, the Java (registered trademark) application 10 (servlet) instructs the Java (registered trademark)-VM 15 to execute the operation.

The above process will be explained based on an example. At the time of setting an intensive copying, the user looks at the animation that explains about the meaning of “½” or “¼” intensive copying (i.e., “½” means a copying of two draft pages in allocation onto one sheet of copying paper, and “¼” means a copying of four draft pages in allocation onto one sheet of copying paper), on the called manual screen of the intensive copying. After the user understands the meaning, the screen asks the user about a selection of a setting (that is, a selection of either “½” or “¼”, and a selection of a layout when there are a plurality of kinds of layout for the allocation). The user clicks a selection key to instruct the setting. When the selection key is clicked, the servlet 11b for general users recognizes that the “½” or “¼” intensive copying has been depressed, and transmits data to the Java (registered trademark)-VM 15 that instructs the copying function of the multi-functional apparatus to execute the operation following the actual setting. The Java (registered trademark)-VM 15 carries out the setting necessary for the multi-functional apparatus to execute the copying operation. The servlet 11b receives a notice of the end of the setting issued from the Java (registered trademark)-VM 15. The servlet 11b transmits the result to the JSP 13b for general users. The JSP 13b prepares a new HTML file based on the result, and transmits this file to the Web browser of the client 20. The client 20 receives the HTML file, and can confirm that the intensive copying has been actually set. Therefore, the client 20 requests the Web server again to shift to the next operation guidance.

Based on the above flow, the copying execution instruction is finally carried out. The multi-functional apparatus 1 executes the copying operation, and outputs the copy. The guidance Web page informs the client 20 in voice about the progress of the operation until all the operation ends.

As explained above, the present invention provides a server that has a Web page to guide a method of operating a console section that inputs a setting to an information processing device. The server recognizes the input of the setting condition through an access to the Web page, and instructs the execution of the control based on the recognized setting condition. Therefore, any person can easily carry out the setting work, and the user can confirm whether the apparatus executes the operation as desired. Consequently, it is possible to gain user's reliability. It is also possible to avoid poor operability that the user must operate while looking at the manual at the side.

Moreover, the server notifies the progress of the instructed execution of the operation. Therefore, the user can understand the operation when the user has instructed the execution at a position far from the information processing device. Consequently, it is possible to improve the reliability.

Furthermore, information that provides an audio support is added to the Web page. Therefore, it is also possible to apply the invention to a client terminal having a limited function such as a portable telephone. Consequently, it is possible to expand the area of utilization.

Moreover, the server prepares the Web page for guiding the operating method that is suitably applied to each operating method that is different for each usage, and selectively uses the Web page. Therefore, it is possible to carry out efficient operation based on a procedure that is optimum for each usage.

Furthermore, the server has a servlet, and a server page that prepares a Web page based on an instruction from the servlet. Therefore, it is also possible to easily build up the Web.

The information processing system according to the present invention employs the information processing device according to the present invention so that it produces the same effects as the information processing device.

The present document incorporates by reference the entire contents of Japanese priority document, 2002-048382 filed in Japan on Feb. 25, 2002.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An information processing device comprising:
a console for inputting a setting condition;
a controller that controls an operation based on the setting condition input; and
a server that has a Web page to guide a user about an input of the setting condition on the console, recognizes the input of the setting condition through an access to the Web page, and instructs the controller to control the operation based on the setting condition recognized.

2. The information processing device according to claim 1, wherein the server prepares a Web page that notifies the progress of the instructed execution of the operation.

3. The information processing device according to claim 1, wherein information that provides an audio support is added to the Web page.

4. The information processing device according to claim 1, wherein the server prepares the Web page that is suitably applied to each operating method different for each usage, and selectively uses the Web page.

5. The information processing device according to claim 1, wherein the server has a servlet, and a server page that prepares a Web page based on an instruction from the servlet.

6. An information processing system comprising:
an information processing device having
a console for inputting a setting condition;
a controller that controls an operation based on the setting condition input; and
a server that has a Web page to guide a user about an input of the setting condition on the console, recognizes the input of the setting condition through an access to the Web page, and instructs the controller to control the operation based on the setting condition recognized; and
a client terminal that is connected to the information processing device via a communicating unit,
wherein the client terminal instructs to input the setting condition based on a request for access to the Web page.
